(19) United States
(12) Patent Application Publication
(10) Pub. No.: US 2023/0341661 A1
(43) Pub. Date: Oct. 26, 2023

(54) MINIATURIZED MONOCULAR TELESCOPIC LASER RANGE FINDER

(71) Applicant: JINHUA LANHAI PHOTOELECTRICITY TECHNOLOGY CO.,LTD., JINHUA (CN)

(72) Inventors: SHANSHAN YANG, JINHUA (CN); XIANGWEI QIAN, JINHUA (CN); CHONGQIU LIU, JINHUA (CN); YIQUN FAN, JINHUA (CN)

(21) Appl. No.: 18/306,426

(22) Filed: Apr. 25, 2023

(30) Foreign Application Priority Data
Apr. 25, 2022 (CN) 202210441903.8

(51) Int. Cl. G02B 13/00; G01S 17/10; G01S 7/481; G02B 23/04; G02B 25/00

(52) U.S. Cl. CPC G02B 13/0065; G01S 17/10; G01S 7/4811; G02B 23/04; G02B 25/001; G02B 13/006

(57) ABSTRACT

The present invention discloses a miniaturized monocular telescopic laser range finder which comprises a receiving and emitting lens group, a focusing negative lens, a beam splitting prism group, an eyepiece group and a laser ranging unit. The receiving and emitting lens group, the focusing negative lens, the beam splitting prism group and the eyepiece group are arranged in sequence from left to right. The receiving and emitting lens group comprises an objective lens and an emitting lens; one side of the objective lens is provided with a groove, and the emitting lens is embedded in the groove. The laser ranging unit is used for emitting laser, receiving the return laser of the laser emitted by the emitting lens, and calculating a distance. The present invention can simultaneously satisfy laser emission and reception through the receiving and emitting lens group, and realizes monocular design and miniaturization.

### TECHNICAL FIELD

The present invention relates to the technical field of laser, and more particularly to a miniaturized monocular telescopic laser range finder.

### BACKGROUND

Laser range finders mainly include pulse-type laser range finders, phase-type laser range finders and trigonometric laser range finders. A telescope laser range finder is most common in the pulse-type laser range finders, comprising a telescope and a laser transceiving module. The process of pulse-type laser range finding is: laser emitted by the range finder is reflected by a measured object and then received by the range finder, the round-trip time of the laser is recorded by the range finder at the same time, half of the product of the speed of light and the round-trip time is the distance between the range finder and the measured object, and then the distance information is displayed on the focal plane of the eyepiece lens and is received and read by an observer.

At present, the telescope range finders on the market are mainly of binocular and trinocular structures in order to achieve the effects of telescoping and ranging at the same time. This design is often large in volume, and not convenient to carry. In order to achieve miniaturization, other range finders are made to have the lenses as small as possible, at the expense of a certain ranging ability.

Therefore, how to provide a miniaturized monocular telescope is an urgent problem for those skilled in the field.

### SUMMARY

In view of this, the present invention provides a miniaturized monocular telescope so that telescoping, emitting and receiving systems share one tube to reduce the volume and realize miniaturization.

To achieve the above purpose, the present invention adopts the following technical solution:

A miniaturized monocular telescopic laser range finder comprises a receiving and emitting lens group, a focusing negative lens, a beam splitting prism group, an eyepiece group and a laser ranging unit.

The receiving and emitting lens group, the focusing negative lens, the beam splitting prism group and the eyepiece group are arranged in sequence from left to right;

The receiving and emitting lens group comprises an objective lens and an emitting lens; one side of the objective lens is provided with a groove, and the emitting lens is embedded in the groove.

The laser ranging unit is used for emitting laser, receiving the return laser of the laser emitted by the emitting lens, and calculating a distance.

Further, the laser ranging unit comprises a laser emitting diode and a laser receiver;

The laser emitting diode is used for emitting laser externally through the emitting lens;

The laser returns after passing through an object, and passes through the objective lens, the focusing negative lens and the beam splitting prism group successively to obtain the return laser;

The laser receiver is used for receiving the return laser split by the beam splitting prism group.

Further, the laser ranging unit further comprises a display device; and the display device is electrically connected with the laser receiver and used for displaying a distance from a measured object.

Further, the laser ranging unit further comprises a light filter, and the light filter is arranged at a receiving end of the laser receiver and used for transmitting band light emitted by a laser emitter.

Further, the beam splitting prism group comprises a roof half penta prism, an isosceles prism and a compensating prism; the roof half penta prism is used for receiving the return laser and the visible light of the object and folding light paths of the return laser and the visible light of the object; the isosceles prism is used for folding the light paths of the return laser and the visible light of the object and outputting the visible light of the object; and the compensating prism is used for outputting the return laser.

Further, the roof half penta prism comprises a light input surface, a reflection and output surface and a roof surface; and the return laser and the visible light of the object are inputted from the light input surface, reflected through the reflection and output surface, reflected through the roof surface, and outputted from the reflection and output surface to the isosceles prism.

Further, the isosceles prism comprises a light input and reflection surface, a light output and reflection surface and a beam splitting surface; the return laser and the visible light of the object are inputted by the light input and reflection surface and reflected to the beam splitting surface through the light output and reflection surface; the beam splitting surface is used for outputting laser to the compensating prism and reflecting the visible light of the object to the light input and reflection surface, and the light output and reflection surface outputs the light to the eyepiece group.

The compensating prism comprises a second beam splitting surface and a light output surface; and the return laser is inputted by the second beam splitting surface and outputted to the laser receiver through the light output surface.

The beam splitting surface of the compensating prism is cemented to the beam splitting surface of the isosceles prism;

A light receiving surface of the roof half penta prism is parallel to the light output surface of the isosceles prism.

Further, the eyepiece group comprises an eyepiece positive lens and an eyepiece cemented lens; and the visible light of the object passes through the eyepiece positive lens and the eyepiece cemented lens successively.

It can be known from the above technical solution that compared with the prior art, the present invention discloses and provides a miniaturized monocular telescopic laser range finder, and an emitting system is formed by a laser emitting diode and an emitting lens; a receiving system is formed by a laser receiver, an objective lens, a focusing negative lens and a beam splitting prism group; a telescopic system is formed by the objective lens, the focusing negative lens, the beam splitting prism group and an eyepiece group; A U-shaped groove is formed in the objective lens for placing the emitting lens. At the same time, the cemented prism combined with the isosceles prism and the compensating prism is matched with the roof half penta prism to make the laser receiving system and the telescopic system share the objective lens, and the telescopic system, the emitting system and the receiving systems share one tube, thereby reducing the system volume, making the range finder more compact and portable and realizing the miniaturization of the range finder. In addition, the focusing negative lens is inserted between the objective lens and the beam splitting prism group to shorten the length the objective lens and reduce the volume; and the range finder is more compact and portable and the miniaturization of the range finder is realized.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a structural schematic diagram of a miniaturized monocular telescopic laser range finder provided by the present invention;

FIG. 2 is a schematic diagram of a light path of a laser emitting system;

FIG. 3 is a schematic diagram of an imaging principle of a receiving and emitting lens group;

FIG. 4 is a schematic diagram of a light path of a beam splitting prism group;

FIG. 5 is a schematic diagram of a light path of visible light of an object of a monocular telescope of a telescopic system;

FIG. 6 is a schematic diagram of a light path of a laser receiving system.

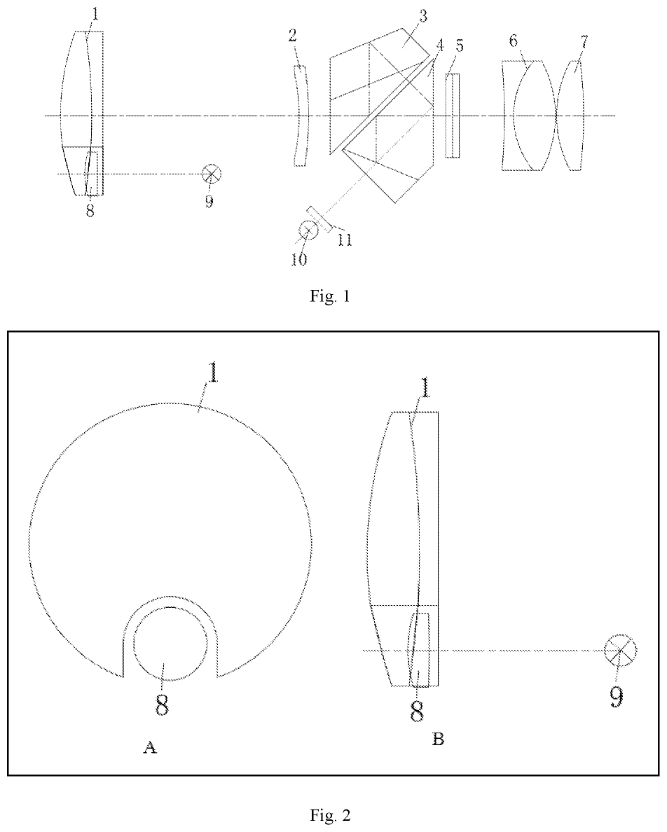

In the figures: 1—objective lens; 2—focusing negative lens; 3—roof half penta prism; 4—cemented prism; 41—isosceles prism; 42—compensating prism; 5—LCD (liquid crystal display) unit; 6—eyepiece cemented lens; 7—eyepiece positive lens; 8—emitting lens; 9—laser emitting diode; 10—laser receiver; 11—light filter.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

Embodiments of the present invention disclose a miniaturized monocular telescopic laser range finder which comprises a receiving and emitting lens group, a focusing negative lens 2, a beam splitting prism group, an eyepiece group and a laser ranging unit.

The receiving and emitting lens group, the focusing negative lens 2, the beam splitting prism group and the eyepiece group are arranged in sequence from left to right.

The receiving and emitting lens group comprises an objective lens 1 and an emitting lens 8; and one side of the objective lens 1 is provided with a groove, and the emitting lens 8 is embedded in the groove.

The laser ranging unit is used for emitting laser, receiving the return laser of the laser emitted by the emitting lens 8, and calculating a distance.

The main purpose of the beam splitting prism group is to fold the light path and reduce the volume. A telescopic system and a receiving (or emitting) system share the objective lens through a beam splitting film, to reduce the ranging volume.

In one embodiment, the laser ranging unit comprises a laser emitting diode 9 and a laser receiver 10;

The laser emitting diode 9 is used for emitting laser externally through the emitting lens;

The laser returns after passing through an object, and passes through the objective lens 1, the focusing negative lens 2 and the beam splitting prism group successively;

The laser receiver 10 is used for receiving the laser split by the beam splitting prism group.

As shown in FIG. 2, the emitting lens 8 is embedded in the U-shaped groove of the objective lens 1, and the laser emitting diode 9 emits laser which exits after passing through the emitting lens 8 embedded in the U-shaped groove of the objective lens 1, to form the emitting system of the range finder.

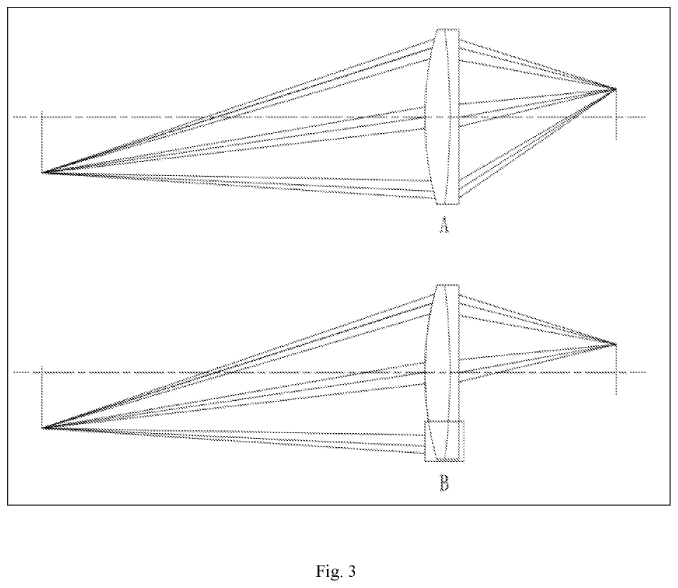

As shown in FIG. 3, during lens imaging, the light path is shown in FIG. 3A. The lower end of the lens is blocked, and the light path is shown in FIG. 3B. According to the imaging principle of off-axis beam and on-axis beam, normal complete imaging may not be affected as long as the blocked part does not exceed the position of an optical axis. Because the light ray that originally passes through the blocked part is lacked, the final imaging brightness is weakened. The normal telescopic function can be satisfied as long as the design of the monocular range finder ensures that the telescopic system still has the original complete objective lens and has 50% of brightness when there is no vignetting after the objective lens is designed with the U-shaped groove.

The laser emitting diode 9 emits laser. The laser is externally emitted through the emitting lens 8 in the groove, and is reflected by a barrier to become return laser. The return laser enters the objective lens 1. The focusing negative lens 2 and the beam splitting prism group can change the light path of the return laser. Finally, the laser is received by the laser receiver 10 and the distance is calculated according to the round-trip time of the laser.

In the present embodiment, the laser ranging unit further comprises a display device 5; the display device 5 is arranged between the beam splitting prism group and the eyepiece group; and the display device 5 is used for displaying a distance measurement result from a measured object.

The measurement result can be seen while telescoping, which makes the observation of the result more real-time, convenient and rapid, wherein the display device 5 is an LCD (liquid crystal display) screen.

In another embodiment, the laser ranging unit further comprises a light filter 11, and the light filter 11 is arranged at a receiving end of the laser receiver 10 and used for transmitting band light emitted by a laser emitter and filtering out other bands of light in the environment to ensure measurement accuracy.

In another embodiment, the beam splitting prism group comprises a roof half penta prism 3, an isosceles prism 41 and a compensating prism 42;

The roof half penta prism 3 is used for receiving the return laser and the visible light of the object and folding light paths of the return laser and the visible light of the object;

The isosceles prism 41 is used for folding the light paths of the return laser and the visible light of the object and outputting the visible light of the object; and

The compensating prism 42 is used for outputting the return laser.

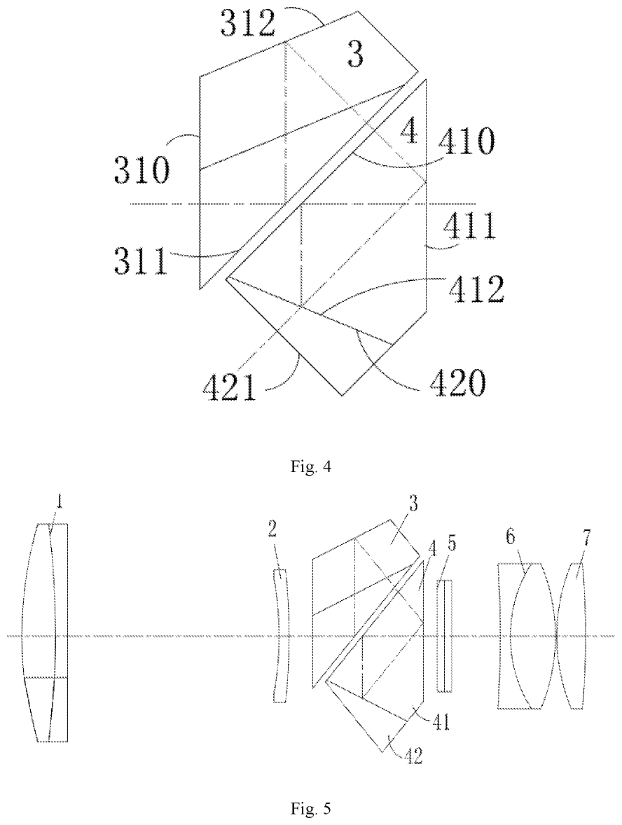

As shown in FIG. 4, in another embodiment, the roof half penta prism 3 comprises a light input surface 310, a reflection and output surface 311 and a roof surface 312; and the laser and the visible light of the object are inputted from the light input surface 310, reflected through the reflection and output surface 311 and the roof surface 312 successively, and finally outputted from the reflection and output surface 311 to the isosceles prism 41.

In the present embodiment, the isosceles prism 41 comprises a light input and reflection surface 410, a light output and reflection surface 411 and a beam splitting surface 412; the laser and the visible light of the object are inputted by the light input and reflection surface 410 and reflected to the beam splitting surface 412 through the light output and reflection surface 411; the beam splitting surface is used for outputting the laser to the compensating prism 42 and reflecting the visible light of the object to the light input and reflection surface 410, and the light output and reflection surface 411 outputs the laser to the eyepiece group to realize a telescopic function.

The compensating prism 42 comprises a second beam splitting surface 420 and a light output surface 421; the laser is inputted by the second beam splitting surface 420 and outputted to the laser receiver 10 through the light output surface 421; the laser receiver 10 calculates the distance from the barrier, i.e., an object to be measured, according to the round-trip time of the laser from emission to reception, to realize a ranging function;

The beam splitting surface of the compensating prism 42 is cemented to the beam splitting surface of the isosceles prism 41;

A light receiving surface of the roof half penta prism 3 is parallel to the light output surface of the isosceles prism 41.

In another embodiment, the eyepiece group comprises an eyepiece positive lens 7 and an eyepiece cemented lens 6;

The visible light of the object passes through the eyepiece positive lens 7 and the eyepiece cemented lens 6 successively.

As shown in FIG. 5, FIG. 5 shows a telescopic system that realizes the telescopic function in the present invention. The light ray of the visible light enters from the objective lens 1, and passes through the focusing lens 2, the roof half penta prism 3, the cemented prism 4, the display device 5, the eyepiece cemented lens 6 and the eyepiece positive lens 7. The eyepiece cemented lens is composed of a concave lens and a convex lens.

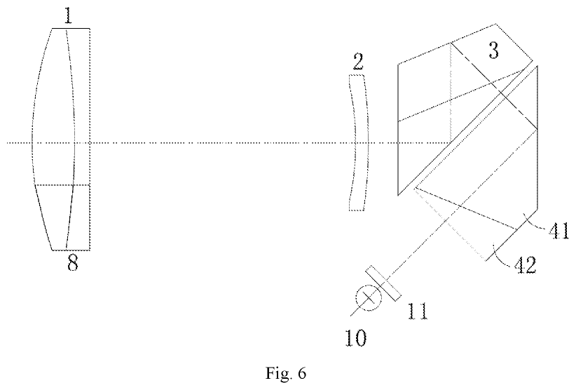

As shown in FIG. 6, FIG. 6 shows a receiving system for receiving the return laser in the present invention. A laser reflection signal of the object to be measured passes through the objective cemented lens 1, the focusing lens 2, the roof half penta prism 3, the cemented prism 4 and the light filter 11, and is finally received by the laser receiver 10.

While ensuring the brightness of the field of view of the telescope, the present invention makes the U-shaped groove treatment for the telescopic objective lens 1, and embeds the emitting lens 8 into the telescopic objective lens. At the same time, the receiving system and the telescopic system share the objective lens 1, to realize the monocular design of the telescopic range finder. Transmissible LCD display is added to the focal surface of the eyepiece, so that the range finder can simultaneously realize telescopic, ranging and display functions in a monocular structure, and ensures that the telescopic range finder is small enough in volume and convenient to carry while ensuring the ranging ability.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A miniaturized monocular telescopic laser range finder, comprising a receiving and emitting lens group, a focusing negative lens, a beam splitting prism group, an eyepiece group and a laser ranging unit, wherein
the receiving and emitting lens group, the focusing negative lens, the beam splitting prism group and the eyepiece group are arranged in sequence from left to right;
the receiving and emitting lens group comprises an objective lens and an emitting lens; one side of the objective lens is provided with a groove, and the emitting lens is embedded in the groove;
the laser ranging unit is used for emitting laser, receiving the return laser of the laser emitted by the emitting lens, and calculating a distance.

2. The miniaturized monocular telescopic laser range finder according to claim 1, wherein the laser ranging unit comprises a laser emitting diode and a laser receiver;
the laser emitting diode is used for emitting laser externally through the emitting lens;
the laser returns after passing through an object, and passes through the objective lens, the focusing negative lens and the beam splitting prism group successively to obtain the return laser;
the laser receiver is used for receiving the return laser split by the beam splitting prism group.

3. The miniaturized monocular telescopic laser range finder according to claim 2, wherein the laser ranging unit further comprises a display device; and the display device is used for displaying a distance from a measured object.

4. The miniaturized monocular telescopic laser range finder according to claim 2, wherein the laser ranging unit further comprises a light filter, and the light filter is arranged at a receiving end of the laser receiver and used for transmitting band light emitted by a laser emitter.

5. The miniaturized monocular telescopic laser range finder according to claim 2, wherein the beam splitting prism group comprises a roof half penta prism, an isosceles prism and a compensating prism;
the roof half penta prism is used for receiving the return laser and the visible light of the object;
the isosceles prism is used for outputting the visible light of the object;
the compensating prism is used for outputting the return laser.

6. The miniaturized monocular telescopic laser range finder according to claim 5, wherein the roof half penta prism comprises a light input surface, a reflection and output surface and a roof surface; and the return laser and the visible light of the object are inputted from the light input surface, reflected through the reflection and output surface, reflected through the roof surface, and outputted from the reflection and output surface to the isosceles prism.

7. The miniaturized monocular telescopic laser range finder according to claim 6, wherein the isosceles prism comprises a light input and reflection surface, a light output and reflection surface and a beam splitting surface; the return laser and the visible light of the object are inputted by the light input and reflection surface and reflected to the beam splitting surface through the light output and reflection surface; the beam splitting surface is used for outputting laser to the compensating prism and reflecting the visible light of the object to the light input and reflection surface, and the light output and reflection surface outputs the light to the eyepiece group;
the compensating prism comprises a second beam splitting surface and a light output surface; and the return laser is inputted by the second beam splitting surface and outputted to the laser receiver through the light output surface;
the beam splitting surface of the compensating prism is cemented to the beam splitting surface of the isosceles prism;
a light receiving surface of the roof half penta prism is parallel to the light output surface of the isosceles prism.

8. The miniaturized monocular telescopic laser range finder according to claim 1, wherein the eyepiece group comprises an eyepiece positive lens and an eyepiece cemented lens;
the visible light of the object passes through the eyepiece positive lens and the eyepiece cemented lens successively.
